(19) United States
(12) Patent Application Publication
(10) Pub. No.: US 2012/0098841 A1
(43) Pub. Date: Apr. 26, 2012

(54) Shared Video Management Subsystem

(76) Inventor: Theodore F. Emerson, Tomball, TX (US)

(21) Appl. No.: 13/375,190

(22) PCT Filed: Jul. 15, 2009
(86) PCT No.: PCT/US2009/050697

§ 371 Date: Nov. 29, 2011

(51) Int. Cl. G06F 13/14

(52) U.S. Cl. 345/520

(57) ABSTRACT

A shared video management subsystem configured to be coupled to and shared by a plurality of independent compute nodes includes a plurality of graphics interfaces configured to receive drawing commands and data from the compute nodes and render graphics information to a frame buffer. The subsystem also includes at least one display refresh controller configured to retrieve the graphics information rendered to the frame buffer and output the graphics information to a display device for display.

### BACKGROUND

Multiple host computer systems that may be coupled through an interconnect infrastructure are becoming increasingly useful in today's computer industry. Unlike more traditional computer systems that include one or more processors functioning under the control of a single operating system, a multiple host distributed computer system typically includes one or more computer processors, each running under the control of a separate operating system. Each of the individually operated computer systems may be coupled to other individually operated computers systems in the network through an infrastructure, such as an infrastructure that includes an Ethernet switch.

One example of a multiple host computer system is a distributed blade computer system. A blade server architecture typically includes a dense collection of processor cards, known as “blades” connected to a common power supply. The blades are generally mounted as trays in a rack that includes a power supply and an interconnect structure configured to provide remote access to the blades. Unlike traditional multi-processor systems, in which a single operating system manages the multiple processors in a unified execution system, the blade server system is generally a collection of independent computer systems, providing benefits, such as low power usage and resource sharing, over traditional separately configured computer systems.

Generally, a blade includes a processor and memory. Further, conventional blades generally include enough components such that each blade comprises a complete computer system with a processor, memory, video chip, and other components included in each blade and connected to a common backplane for receiving power and an Ethernet connection. As computer resources become denser, it is useful to optimize each computer resource so that it utilizes its allocated space and power efficiently. Because each blade is typically configured to perform as a “stand alone” server containing, among other things, a video controller, keyboard/video/mouse (KVM) redirection logic, and a management processor, each blade may be coupled to a video monitor to provide a stand-alone computer resource. However, in modern data centers, systems are typically deployed in a “lights-out” configuration such that they are not connected to video monitors. Nevertheless, each individual blade is disadvantageously burdened with the extra cost, power and space of a video controller and the associated redirection subsystem on each blade.

### SUMMARY

One embodiment is a shared video management subsystem configured to be coupled to and shared by a plurality of independent compute nodes. The subsystem includes a plurality of graphics interfaces configured to receive drawing commands and data from the compute nodes and render graphics information to a frame buffer. The subsystem also includes at least one display refresh controller configured to retrieve the graphics information rendered to the frame buffer and output the graphics information to a display device for display.

### BRIEF DESCRIPTION OF THE DRAWINGS

FIG. 1 is a block diagram illustrating a multi-node computer system with a shared video management subsystem according to one embodiment.

FIG. 2 is a block diagram illustrating a video management subsystem of the computer system shown in FIG. 1 according to one embodiment.

FIG. 3 is a flow diagram illustrating a method of operating a computer system that includes a plurality of independent compute nodes according to one embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

A video controller typically includes three basic parts: a host/rendering interface, a frame buffer, and a display engine. In blade server implementations, video hardware is a typical server component for many operating systems, even though the video controller's output is ordinarily unconnected and inaccessible to the user. As a result, system designers typically implement a full video controller with all of the typical memory and components on these theoretically “headless” servers. Each video controller consumes valuable system resources such as board real-estate and power. Additionally, a typical VGA compatible graphics architecture is unintelligent and is constructed to display a video image regardless of the presence of a display device. This display operation is by far the most memory intensive operation performed by a graphics controller and is constant, as display information for typical displays is refreshed 60 to 85 times per second.

In prior bladed architectures, a complete video controller is populated on every blade. Each blade also typically contains an embedded management controller with keyboard/video/mouse (KVM) capabilities. In these systems, the video controller is constantly drawing its output regardless of whether a KVM session is in progress. This is disadvantageous as every blade carries the cost, board real-estate, and power burdens of these components. Other implementations, such as systems without embedded KVM over IP hardware, may consolidate the video from several blades by connecting the multiple video output streams to a centralized KVM infrastructure. Like the previously discussed implementations, however, each blade carries the cost and power burden of the video subsystem and the infrastructure has to be configured to route high speed video signals between blades.

One embodiment provides a computer system with a partitioned architecture that allows multiple computers or multiple computer partitions to render video information into a shared memory area. This allows multiple compute nodes to share video display resources, decreasing solution cost and power.

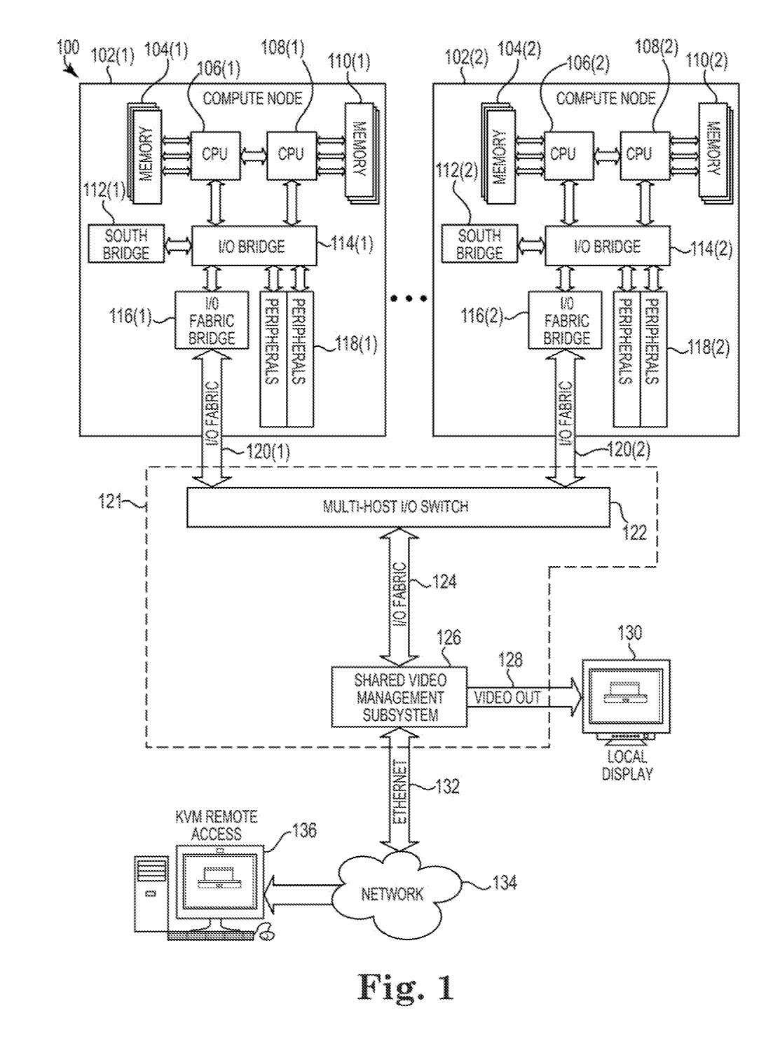

FIG. 1 is a block diagram illustrating a multi-node computer system 100 with a shared video management subsystem 126 according to one embodiment. System 100 includes a plurality of compute nodes or hosts 102(1)-102(2) (collectively referred to as compute nodes 102 or hosts 102), a multi-host input/output (I/O) switch 122, a shared video management subsystem 126, a local display device 130, and KVM remote access unit 136. Compute node 102(1) includes memories 104(1) and 110(1), central processing units (CPUs) 106(1) and 108(1), south bridge 112(1), I/O bridge 114(1), I/O fabric bridge 116(1), and a plurality of peripherals 118(1). CPU 106(1) is coupled to memory 104(1), CPU 108(1), and I/O bridge 114(1). CPU 108(1) is coupled to CPU 106(1), memory 110(1), and I/O bridge 114(1). In addition to being coupled to CPUs 106(1) and 108(1), I/O bridge 114(1) is also coupled to south bridge 112(1), I/O fabric bridge 116(1), and peripherals 118(1). I/O fabric bridge 116(1) is coupled to multi-host I/O switch 122 via communication link 120(1). In the illustrated embodiment, compute node 102(2) includes the same elements and is configured in the same manner as compute node 102(1), but a “(2)” rather than a “(1)” is appended to the reference numbers for compute node 102(2).

In one embodiment, computer system 100 is a distributed blade computer system, and each one of the compute nodes 102 is implemented as a blade in that system, and each one of the compute nodes 102 comprises a stand-alone computer system on a single card, but without video capabilities. In the illustrated embodiment, switch 122 and shared video management system 126 are included in an enclosure or infrastructure 121, such as a backplane in a rack mount system, and each of the compute nodes 102 (e.g., blades) is coupled to the infrastructure 121. The infrastructure 121 according to one embodiment provides power and network connections for each of the compute nodes 102 in the system 100. In one embodiment, switch 122 is a Peripheral Component Interconnect Express (PCI-E) switch.

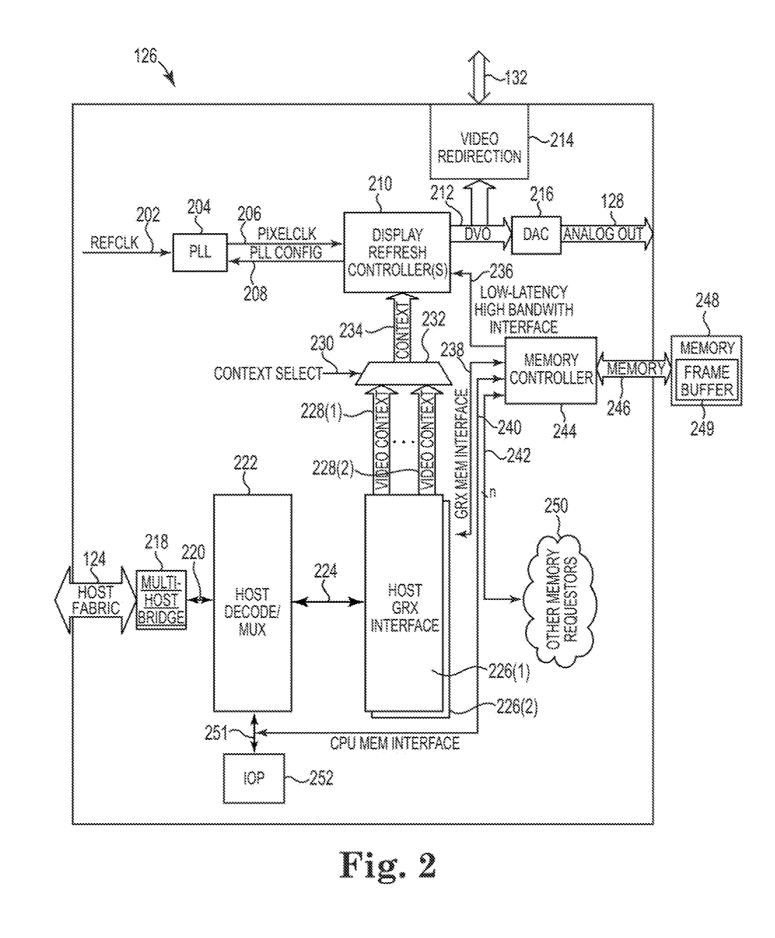

In the illustrated embodiment, the plurality of compute nodes 102 are operationally coupled to the subsystem 126 via a central multi-system fabric that includes the multi-host I/O switch 122. In one embodiment, the I/O fabric interconnect for the compute nodes 102 is performed through dedicated I/O fabric bridges 116(1) and 116(2) in the compute nodes 102. In one form of this embodiment, the I/O fabric bridges 116(1) and 116(2) (and the bridge 218 shown in FIG. 2 and described below) encapsulate requests and responses with additional routing information to support the sharing of the fabric with multiple independent nodes 102. In another embodiment, the I/O fabric interconnect for the compute nodes 102 may be part of the main I/O bridges 114(1) and 114(2) of the compute nodes 102.

In one embodiment, the multi-host I/O switch 122 routes I/O, configuration, and memory cycles from each compute node 102 to the attached shared video management subsystem 126, and selectively routes information from the subsystem 126 to appropriate ones of the nodes 102, such as routing a response from subsystem 126 to a particular one of the nodes 102 that sent a request to the subsystem 126. In one embodiment, transactions transmitted through the switch 122 include information indicating the destination interconnect number and device, which allows the switch 122 to determine the transaction routing. In one embodiment, each bus cycle includes a source and destination address, command and data, and a host identifier to allow the shared video management subsystem 126 to return data to the proper compute node 102. In one embodiment, communication links 120 and 124 are each a PCI-E bus and switch 122 is a PCI-E switch, although other interconnects and switches may be used in other embodiments.

As shown in FIG. 1, multi-host I/O switch 122 is coupled to shared video management subsystem 126 via communication link 124. Subsystem 126 is also coupled to local display device 130 via communication link 128, and to KVM remote access unit 136 via communication link 132 and network (e.g., Ethernet) 134. In one embodiment, video capabilities of the plurality of compute nodes 102 are disaggregated from these nodes 102, and provided by shared video management subsystem 126 for sharing by the plurality of nodes 102. The shared video management subsystem 126 according to one embodiment provides each of the compute nodes 102 with video rendering hardware as well as a centralized video output (e.g., through communication link 128 to display device 130) and remote KVM redirection (e.g., through communication link 132 and network 134 to KVM remote access unit 136).

In the illustrated embodiment, none of the compute nodes 102 includes a corresponding local display device, or video graphics hardware (e.g., a video controller, a KVM redirection unit, etc.). As described in further detail below with reference to FIG. 2, the video graphics functions are off-loaded from the nodes 102 and incorporated into the shared video management subsystem 126, thereby decoupling the display technology from the computer technology and providing improved functionality of the system 100.

FIG. 2 is a block diagram illustrating a shared video management subsystem 126 of the computer system 100 shown in FIG. 1 according to one embodiment. Subsystem 126 includes phase locked loop (PLL) 204, at least one display refresh controller 210, video redirection unit 214, digital-to-analog converter (DAC) 216, multi-host bridge 218, host decoder/multiplexer (MUX) 222, a plurality of host graphics (GRX) interfaces 226(1)-226(2) (collectively referred to as host GRX interfaces 226), multiplexer 232, memory controller 244, memory 248, other memory requestors 250, and input/output processor (TOP) 252. In one embodiment, subsystem 126 is implemented in a single application specific integrated circuit (ASIC), and host GRX interfaces 226 and display refresh controller 210 are architecturally separated from each other at the module level and implemented with separate intellectual property (IP) modules in the ASIC with wire interconnections between the modules. In another embodiment, subsystem 126 is implemented in a plurality of integrated circuits or discrete components.

A conventional video controller module typically includes rendering hardware, as well as hardware for providing a continuous video output waveform. In the embodiment shown in FIG. 2, these two functions have been decoupled or segregated into separate functional blocks, which are the host GRX interfaces 226 and the display refresh controller 210. The host GRX interfaces 226 according to one embodiment represent the main graphics controller rendering hardware from the host perspective. In one embodiment, system 100 is configured such that any one of the compute nodes 102 may be selectively coupled to any one of the host GRX interfaces 226.

In one embodiment, the plurality of host GRX interfaces 226 receive drawing commands and data from the compute nodes 102 and render graphics information to a frame buffer 249, and the display refresh controller 210 retrieves the graphics information rendered to the frame buffer 249 and outputs the graphics information to display device 130 for display. More specifically, to present information to a user, applications running on the compute nodes 102 send drawing commands and data through an operating system driver to the multi-host input/output switch 122, which transfers the information from the compute nodes 102 to the shared video management subsystem 126. Multi-host bridge 218 receives the commands and data from the nodes 102 via communication link 124, and provides them to host decoder/multiplexer 222 via communication link 220. Host decoder/multiplexer 222 routes the commands and data to appropriate ones of the host GRX interfaces 226 via communication links 224. In this manner, host decoder/multiplexer 222 according to one embodiment selectively couples drawing commands and data from the compute nodes 102 to selected ones of the plurality of host GRX interfaces 226. The host GRX interfaces 226 receive the drawing commands and data, and translate them into rendering operations that render corresponding graphics data to an attached frame buffer area 249 in memory 248 via communication link 238, memory controller 244, and communication link 246.

In one embodiment, frame buffer 249 stores video graphics images written by host GRX interfaces 226 for display on the display device 130. In the illustrated embodiment, memory 248 is a centralized memory store for the management subsystem 126, and the frame buffer 249 is a predetermined portion of this memory 248. In one embodiment, memory 248 stores one or more frame buffer contexts, as well as code and data for the rest of the management subsystem 126. In the illustrated embodiment, IOP 252 and other memory requestors 250 in subsystem 126 are configured to access memory 248 via communication links 240 and 242, respectively. Memory 248 is a DDR3 synchronous DRAM in one embodiment.

The display refresh controller 210 according to one embodiment provides a continuous video output waveform via digital video output (DVO) communication link 212 based on a pixel clock (PIXELCLK) signal received from PLL 204 on communication link 206. PLL 204 generates the pixel clock signal based on a reference clock (REFCLK) signal provided by a reference crystal and received on communication link 202, and based on multiplier/divider information in PLL configuration (PLL CONFIG) information received from display refresh controller 210 on communication link 208. The REFCLK according to one embodiment is fixed, and is selected based on a desired frequency list. The system designer may select a REFCLK frequency that allows the desired frequencies to be obtained given the multiply and divide capabilities of the PLL 204. In one embodiment, PLL 204 is configured to generate a PIXELCLK that is within a predetermined frequency range (e.g., 0.5%) of a theoretical desired frequency. In one embodiment, display refresh controller 210 receives graphics data (e.g., video data) from the frame buffer 249 via communication link 236, memory controller 244, and communication link 246, and presents the data to display device 130 (FIG. 1) via communication link 212, DAC 216, and communication link 128. DAC 216 converts the digital video signal output by display refresh controller 210 on communication link 212 to an analog signal suitable for use by the display device 130.

In one embodiment, the display refresh controller 210 “draws” the entire screen on display device 130 several times a second (e.g., 50-85 times a second), to create a visually persistent image that is visually responsive to the user. That is, when the host GRX interfaces 226 render or otherwise change the contents of the frame buffer 249, the result is communicated to the display device 130 by the display refresh controller 210 in a relatively short time period to facilitate full motion video on the display device 130.

In one embodiment, the at least one display refresh controller 210 includes a plurality of display refresh controllers. In the illustrated embodiment, the at least one display refresh controller 210 is partitioned and logically decoupled from the host GRX interfaces 226. In this way, M display refresh controllers 210 can operate on N host GRX interfaces 226, where M and N represent integers greater than or equal to one. This decoupling allows the display logic (e.g., display refresh controller 210) to scale with the desired number of video output ports (e.g., such as communication link 128) while the rendering logic (e.g., host GRX interfaces 226) can scale with the number of nodes 102 for which graphics support is desired. In one embodiment, the total number of host GRX interfaces 226 in subsystem 126 is different than the total number of display refresh controllers 210 in subsystem 126, and in another embodiment, these numbers are the same. In one embodiment, for each additional display refresh controller 210 that is added to subsystem 126, an additional PLL 204, DAC 216, and multiplexer 232 are also added, along with corresponding communication links.

Each one of the host GRX interfaces 226 outputs video context data to multiplexer 232 via one of a plurality of communication links 228(1)-228(2) (collectively referred to as communication links 228). In one embodiment, the video context data for a given host GRX interface 226 identifies the location in frame buffer 249 of graphics data rendered by that GRX interface 226. The video context data according to one embodiment communicates the current operating video mode, the PLL configuration, the location of any video or cursor overlays, as well as other information. The video context data according to one embodiment is an extensive set of configuration variables that uniquely identifies the display process of the selected host GRX interface 226. In one embodiment, IOP 252 sends a context select signal to multiplexer 232 via communication link 230 to select one of the video contexts on communication links 228. The selected video context is output by multiplexer 232 to display refresh controller 210 on communication link 234. In this manner, multiplexer 232 according to one embodiment selectively couples the plurality of host GRX interfaces 226 to the display refresh controller 210. Based on the selected context, display refresh controller 210 accesses the graphics data corresponding to the selected context from frame buffer 249, and causes the graphics data to be displayed.

In one embodiment, KVM remote access unit 136 (FIG. 1) is configured to access any of the compute nodes 102 in the system 100 through the infrastructure 121. In order to access graphics functions for a given one of the nodes 102, unit 136 accesses the shared video management subsystem 126. The video redirection unit 214 in the subsystem 126 captures the digital video output on communication link 212, and compresses, encodes, and encrypts the captured data. In one embodiment, the resulting data stream is placed into packets consistent with the transmit medium (e.g., Ethernet packets for an Ethernet network, for instance) by the video redirection unit 214, and transmitted via communication link 132 and network 134 (FIG. 1) to the KVM remote access unit 136. These packets are then decrypted, decoded, and decompressed by the remote access unit 136, and the redirected image is rendered to a display device of the remote access unit 136. In one embodiment, unit 214 also includes circuitry to route keystrokes and mouse status from the nodes 102 to the remote access unit 136.

In one embodiment, subsystem 126 is configured to shut down the display operation of video output by display refresh controller 210 when such output is not desired. In this way, the subsystem 126 serves as a video management agent and provides an intelligent allocation of graphics hardware. In one embodiment, IOP 252 is configured to detect when a display device 130 is attached, and cause display refresh controller 210 and DAC 216 to be powered on when a display device is attached or when a remote KVM session is in progress, and cause display refresh controller 210 and DAC 216 to be powered off when such conditions are not present. IOP 252 according to one embodiment provides general control and functions as a management processor for subsystem 126, including the control of host decoder/multiplexer 222 via communication link 251.

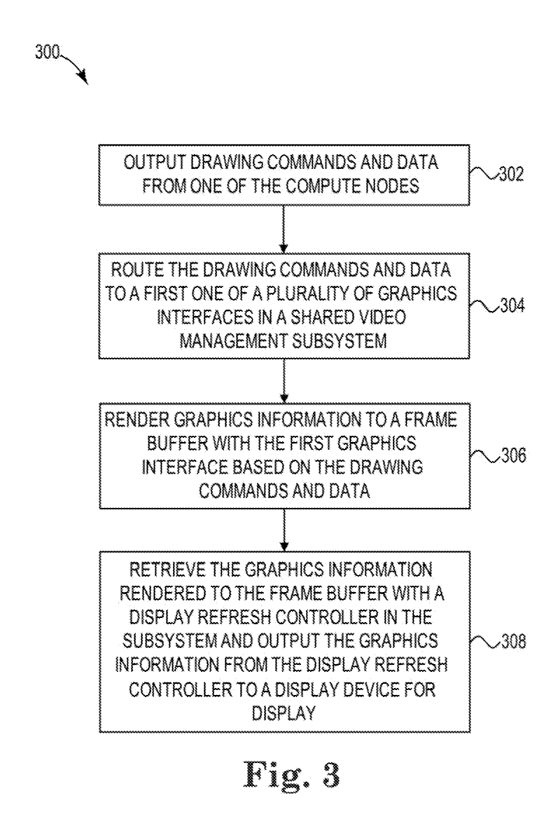

FIG. 3 is a flow diagram illustrating a method 300 of operating a computer system 100 that includes a plurality of independent compute nodes 102 according to one embodiment. In one embodiment, the computer system 100 in method 300 includes a shared video management subsystem 126 that is configured to be coupled to and shared by the plurality of compute nodes 102. At 302 in method 300, drawing commands and data are output from one of the compute nodes 102. At 304, the drawing commands and data are routed to a first one of a plurality of graphics interfaces 226 in a shared video management subsystem 126 in the computer system 100. At 306, graphics information is rendered to a frame buffer 249 by the first graphics interface based on the drawing commands and data. At 308, the graphics information rendered to the frame buffer 249 is retrieved by a display refresh controller 210 in the subsystem, and the graphics information is output from the display refresh controller to a display device 130 for display.

Some or all of the functions described herein may be implemented as computer-executable instructions stored in a computer-readable medium. The instructions can be embodied in any computer-readable medium for use by or in connection with a computer-based system that can retrieve the instructions and execute them. A computer-readable medium according to one embodiment can be any means that can contain, store, communicate, propagate, transmit, or transport the instructions. The computer readable medium can be an electronic, a magnetic, an optical, an electromagnetic, or an infrared system, apparatus, or device. An illustrative, but non-exhaustive list of computer-readable mediums can include an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

The multi-node computer system 100 with the shared video management subsystem 126 according to one embodiment allows multiple nodes 102 to share graphics display hardware. In one embodiment, each compute node 102 (e.g., blade or system partition) no longer includes a discrete video subsystem, freeing up valuable resources such as board real-estate and power. Instead of each node 102 constantly rendering a video image to a possibly non-existent display device, as in some conventional systems, only “used” video outputs are provided in one form of system 100. For example, instead of providing video output connectors for each blade in an enclosure, one “unified” video output 128 is implemented in the enclosure 121, providing the customer with a simpler solution and reducing power consumption for blades that are not being monitored. The intelligent management subsystem 126 according to one embodiment allows for integrated local KVM access to multiple machines as well as video redirection capabilities over the network 134 (i.e., KVM over IP). System 100 according to one embodiment correctly aligns the implemented video hardware with how the product is actually used, which reduces the complexity of each node 102 and provides a significant step to achieving the desirable goal of “shared legacy I/O.”

Advantageously, the system 100 according to one embodiment eliminates video hardware from computing resources (i.e., the compute nodes 102) and allows the video hardware to be dynamically scaled based on the usage model of a particular customer. For instance, if many nodes 102 need to be managed simultaneously, many video resources (e.g., host GRX interfaces 226) can be added to the infrastructure 121. If fewer nodes 102 need to be managed simultaneously, the customer can populate fewer video resources within the infrastructure 121. Further, the amount of video resources can be adjusted with the changing needs of the customer. In addition, each node 102 benefits by having fewer components and consuming less power.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A shared video management subsystem configured to be coupled to and shared by a plurality of independent compute nodes, comprising:
a plurality of graphics interfaces configured to receive drawing commands and data from the compute nodes and render graphics information to a frame buffer; and
at least one display refresh controller configured to retrieve the graphics information rendered to the frame buffer and output the graphics information to a display device for display.

2. The subsystem of claim 1, wherein the at least one display refresh controller comprises a plurality of display refresh controllers.

3. The subsystem of claim 2, wherein a total number of the graphics interfaces in the subsystem is different than a total number of the display refresh controllers in the subsystem.

4. The subsystem of claim 1, wherein the compute nodes comprise blades.

5. The subsystem of claim 4, wherein the subsystem is implemented in an infrastructure coupled to the blades.

6. The subsystem of claim 1, and further comprising:
a video redirection unit configured to capture the graphics data output by the display refresh controller and output the captured graphics data to a remote access unit via a network.

7. The subsystem of claim 1, wherein the subsystem is implemented in a single application specific integrated circuit (ASIC).

8. The subsystem of claim 7, wherein the at least one display refresh controller is architecturally separated from the plurality of graphics interfaces at a module level.

9. The subsystem of claim 1, and further comprising:
a multiplexer configured to selectively couple drawing commands and data from the compute nodes to selected ones of the plurality of graphics interfaces.

10. The subsystem of claim 1, and further comprising:
a multiplexer configured to selectively couple the plurality of graphics interfaces to the at least one display refresh controller.

11. The subsystem of claim 1, wherein the plurality of compute nodes each comprise a stand-alone computer system on a single card without a video controller.

12. A computer system, comprising:
a plurality of independent compute nodes; and
a shared video management subsystem configured to be shared by the plurality of compute nodes, the subsystem comprising:
a plurality of graphics interfaces configured to receive drawing commands and data from the compute nodes and render graphics information to a frame buffer; and
at least one display refresh controller configured to retrieve the graphics information rendered to the frame buffer and output the graphics information to a display device for display.

13. The computer system of claim 12, wherein the at least one display refresh controller comprises a plurality of display refresh controllers, and wherein a total number of the graphics interfaces in the subsystem is different than a total number of the display refresh controllers in the subsystem.

14. The computer system of claim 12, wherein the subsystem further comprises:
a first multiplexer configured to selectively couple drawing commands and data from the compute nodes to selected ones of the plurality of graphics interfaces; and
a second multiplexer configured to selectively couple the plurality of graphics interfaces to the at least one display refresh controller.

15. A method of operating a computer system that includes a plurality of independent compute nodes, the method comprising:
outputting drawing commands and data from one of the compute nodes;
routing the drawing commands and data to a first one of a plurality of graphics interfaces in a shared video management subsystem in the computer system;
rendering graphics information to a frame buffer with the first graphics interface based on the drawing commands and data; and
retrieving the graphics information rendered to the frame buffer with a display refresh controller in the subsystem and outputting the graphics information from the display refresh controller to a display device for display.
